(19) United States
(12) Patent Application Publication
(10) Pub. No.: US 2025/0348744 A1
(43) Pub. Date: Nov. 13, 2025

(54) ARTIFICIAL INTELLIGENCE GENERATED CONTENT GIFTING

(71) Applicant: Microsoft Technology Licensing, LLC, Redmond, WA (US)

(72) Inventors: Rolly SETH, Kirkland, WA (US); Alexandre GUENIOT, Mountain View, CA (US); Qijin ZHOU, Bellevue, WA (US); Luke HEINE, San Franciso, CA (US); Patrick Christopher RYAN, Poulsbo, WA (US)

(73) Assignee: Microsoft Technology Licensing, LLC, Redmond, WA (US)

(21) Appl. No.: 18/658,594

(22) Filed: May 8, 2024

(51) Int. Cl. G06N 3/091; G06F 9/451; G06F 40/58; G06N 3/0475

(52) U.S. Cl. CPC G06N 3/091; G06F 9/451; G06N 3/0475; G06F 40/58

(57) ABSTRACT

A data processing system implements obtaining digital content as an output from the generative model; receiving a natural language prompt describing digital wrapping for the digital content, the digital wrapping to be presented to a recipient of the digital content; constructing a prompt based on the natural language prompt using the prompt construction unit; providing the second prompt to the generative model to cause the generative model to generate the digital wrapping; obtaining the digital wrapping as an output from the generative model; sending the digital content and the digital wrapping to a client device of a recipient; and causing the client device to present the digital wrapping on a second user interface of a client device and controls, which when activated, cause the client device to present an animation of the digital wrapping being removed and the digital content to be presented.

### BACKGROUND

Numerous tools and design applications have been created that utilize generative artificial intelligence (AI) to assist users in creating and/or laying out content. Users often create content that they intend to share with other users. This content may include, but is not limited to cards, graphics, invitations, announcements, and/or other type of content. Currently, users creating such content have limited options for sharing this content with other users. The users may email the content to another user or include it in another type of message to the user. However, these options provide users with little or no control over how the content is presented to the recipient. Hence, there is a need for improved systems and methods that provide means for customizing how the shared content is presented to the recipient.

### SUMMARY

An example data processing system according to the disclosure includes a processor and a memory storing executable instructions. The instructions when executed cause the processor alone or in combination with other processors to perform operations including receiving, from a first user interface of an application, a first natural language utterance describing digital content to be generated; constructing a first prompt, using a prompt construction unit, the first prompt being based on the first natural language utterance instructing a generative model to generate the digital content; providing the first prompt to the generative model to cause the generative model to generate the digital content; obtaining the digital content as an output from the generative model; receiving a second natural language utterance describing digital wrapping for the digital content, the digital wrapping to be presented to a recipient of the digital content, the digital wrapping providing a virtual experience of receiving and unwrapping a gift comprising the digital content; constructing a second prompt based on the second natural language utterance using the prompt construction unit, the second prompt comprising instructions to the generative model to generate content comprising one or more images representing the digital wrapping; providing the second prompt to the generative model to cause the generative model to generate the digital wrapping; obtaining the digital wrapping as an output from the generative model; sending the digital content and the digital wrapping to a client device of a recipient; and causing the client device to present the digital wrapping on a second user interface of the client device and controls, which when activated, cause the client device to present an animation of the digital wrapping being removed and the digital content to be presented.

An example method implemented in a data processing system includes receiving, from a first user interface of an application, a first natural language utterance describing digital content to be generated; constructing a first prompt, using a prompt construction unit, the first prompt being based on the first natural language utterance instructing a generative model to generate the digital content; providing the first prompt to the generative model to cause the generative model to generate the digital content; obtaining the digital content as an output from the generative model; receiving a second natural language utterance describing digital wrapping for the digital content, the digital wrapping to be presented to a recipient of the digital content, the digital wrapping providing a virtual experience of receiving and unwrapping a gift comprising the digital content; constructing a second prompt based on the second natural language utterance using the prompt construction unit, the second prompt comprising instructions to the generative model to generate content comprising one or more images representing the digital wrapping; providing the second prompt to the generative model to cause the generative model to generate the digital wrapping; obtaining the digital wrapping as an output from the generative model; sending the digital content and the digital wrapping to a client device of a recipient; and causing the client device to present the digital wrapping on a second user interface of the client device and controls, which when activated, cause the client device to present an animation of the digital wrapping being removed and the digital content to be presented.

An example data processing system according to the disclosure includes a processor and a memory storing executable instructions. The instructions when executed cause the processor alone or in combination with other processors to perform operations including receiving, in a user interface of an application on a client device, a natural language utterance describing digital wrapping for digital content, the digital wrapping to be presented to a recipient of the digital content; sending the digital content and the natural language utterance to a wrapping generation pipeline to analyze the digital content and the natural language utterance and generate the digital wrapping based on the digital content and the natural language utterance; obtaining the digital wrapping as an output from the wrapping generation pipeline; presenting, on the user interface of the application on the client device, the digital wrapping on a second user interface of the client device and controls, which when activated, cause the client device to present an animation of the digital wrapping being removed and the digital content to be presented; and sending an indication to the wrapping generation pipeline to send a link to the digital content and the digital wrapping to a recipient.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram of an example computing environment in which the techniques for generating digital wrapping using generative models described herein are implemented.

FIG. 2A is a diagram showing an example implementation of the wrapping generation pipeline shown in FIG. 1.

FIG. 2B is a diagram showing an example of a series of prompts constructed by the wrapping generation pipeline used to generate digital wrapping and associated digital accessories.

FIG. 3 is a diagram showing another example implementation of the wrapping presentation pipeline shown in FIG. 1.

FIGS. 4A-4E are diagrams showing example user interfaces of an application which implements the techniques for generating digital wrapping according to the techniques disclosed herein.

FIGS. 4F-4H are diagrams showing example user interfaces of an application presenting shared content and the digital wrapping to a recipient.

FIG. 5A is a flow chart of another example process for generating virtual wrapping for digital content according to the techniques disclosed herein.

FIG. 5B is a flow chart of another example process for presenting virtual wrapping for digital content according to the techniques disclosed herein.

FIG. 6 is a block diagram showing an example software architecture, various portions of which may be used in conjunction with various hardware architectures herein described, which may implement any of the described features.

FIG. 7 is a block diagram showing components of an example machine configured to read instructions from a machine-readable medium and perform any of the features described herein.

### DETAILED DESCRIPTION

Systems and methods for automatically generating digital wrapping for content items using generative models are provided herein. These techniques utilize a large language model (LLM) to generate digital content based on a natural language utterance and to generate custom digital wrapping that is included with the content item when the content item is shared with other users. The digital wrapping comprises a digital gift wrap that provides an immersive and personalized experience for recipients of content item. The recipient is provided with a virtual experience of receiving and unwrapping a gift in which an animation of the digital wrapping is unwrapped to reveal the digital content item.

The techniques herein enable users to describe the custom digital wrapping in a natural language utterance and the techniques herein construct a prompt that causes the LLM to generate the requested content based on the natural language utterance. The techniques herein also generate a digital envelope or a digital gift box with wrapping paper based on the description provided in the natural language utterance used to generate the content item or on subsequent natural language utterances input by the user that describe the type and attributes of the digital wrapping to be generated. The user can specify various attributes of the digital wrapping, such as a color or colors to be utilized, a pattern or image to be applied to the digital wrapping, and/or other attributes of the digital wrapping that provide the generative model with context when generating the digital wrapping. The techniques herein can also guide the user through creating digital accessories for the digital wrapping, such as but not limited to digital stickers, wax seals, ribbons, name tags, and/or other decorative items that can further enhance the digital wrapping. The digital wrapping and accessories can be generated using various generative language models, such as but not limited to Dall-E 3 or Generative Pre-trained Transformer (GPT) 3 or GPT-4. A technical benefit of this approach is that the generative model is provided carefully constructed, customized, and well-engineered prompts that are tailored for creating the digital wrapping and/or accessories, which improves the performance of the generative model when generating this content. Another technical benefit of this approach is that presenting the user with relevant and well-integrated digital wrapping and/or accessories not only improves the user experience but also reduces the computing resources consumed because users are less likely to regenerate the digital wrapping and/or accessories repeatedly to obtain a result that satisfies their requirements. These and other technical benefits of the techniques disclosed herein will be evident from the discussion of the example implementations that follow.

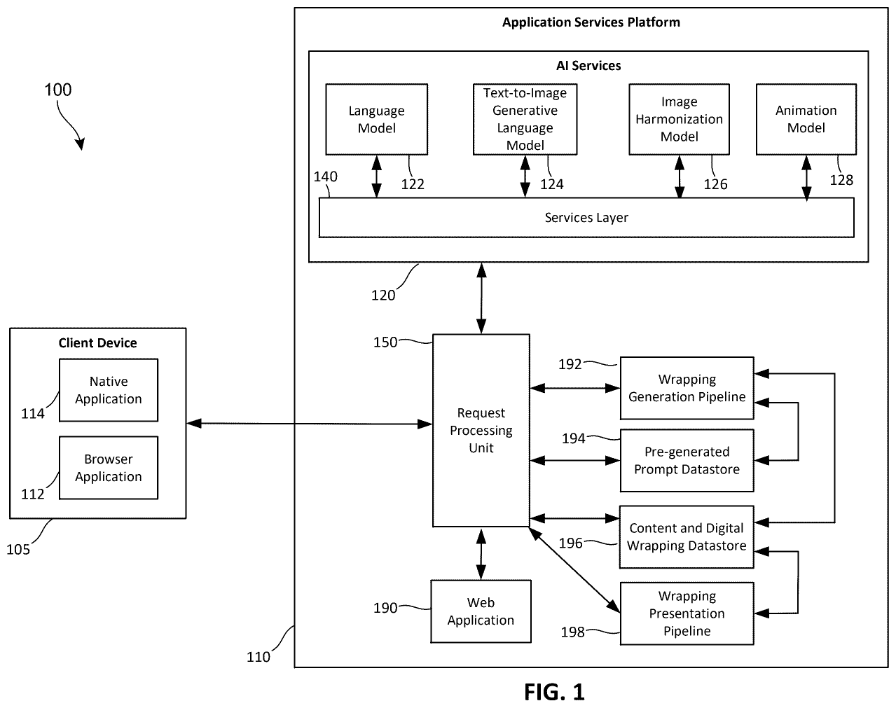

FIG. 1 is a diagram of an example computing environment 100 in which the techniques described herein are implemented. The example computing environment 100 includes a client device 105 and an application services platform 110. The application services platform 110 provides one or more cloud-based applications and/or provides services to support one or more web-enabled native applications on the client device 105. These applications may include but are not limited to design applications, communications platforms, visualization tools, and collaboration tools for collaboratively creating visual representations of information, and other applications for consuming and/or creating electronic content. These applications utilize generative AI to generate content that can be utilized in the applications and/or shared with other users. The applications enable users to share the generated content with other users and to generate digital wrapping and/or accessories using the generative AI. The client device 105 and the application services platform 110 communicate with each other over a network (not shown). The network may be a combination of one or more public and/or private networks and may be implemented at least in part by the Internet.

The application services platform 110 includes a request processing unit 150, artificial intelligence (AI) services 120, a web application 190, a wrapping generation pipeline 192, a pre-generated prompt datastore 194, a content and digital wrapping datastore 196, and wrapping presentation pipeline 198. The request processing unit 150 is configured to receive requests from an application implemented by the native application 114 of the client device 105 and/or the web application 190 of the application services platform 110. The requests may include but are not limited to requests to generate new content, to generate a digital wrapping and/or accessories for the content, to share the content with the digital wrapping and/or accessories with other users, and/or perform other actions as discussed in the examples which follow. The generated content may include, but is not limited to images, cards, announcements, web pages, blogs, social media posts, invitations, drawings, posters, videos and/or advertisements. The application provides a user interface that enables users to input natural language utterances requesting that the application generate various types of content discussed above, for modifying the content and/or the layout thereof. The user interface also enables users to input natural language utterances requesting that the application generate digital wrapping, such as but not limited to envelopes or boxes, and/or digital accessories such as but not limited to digital stickers, wax seals, ribbons, name tags, and/or other decorative items that can further enhance the digital wrapping. The application relies on one or more generative models provided by the artificial intelligence (AI) services 120 to generate or modify content item, and the digital wrapping and/or accessories of the digital wrapping. In some implementations, the web application 190 of the application services platform 110 implements this functionality of the design application. In other implementations, at least a portion of this functionality is implemented by the native application 114 of the client device 105. The request processing unit 150 also coordinates communication and exchange of data among components of the application services platform 110 as discussed in the examples which follow.

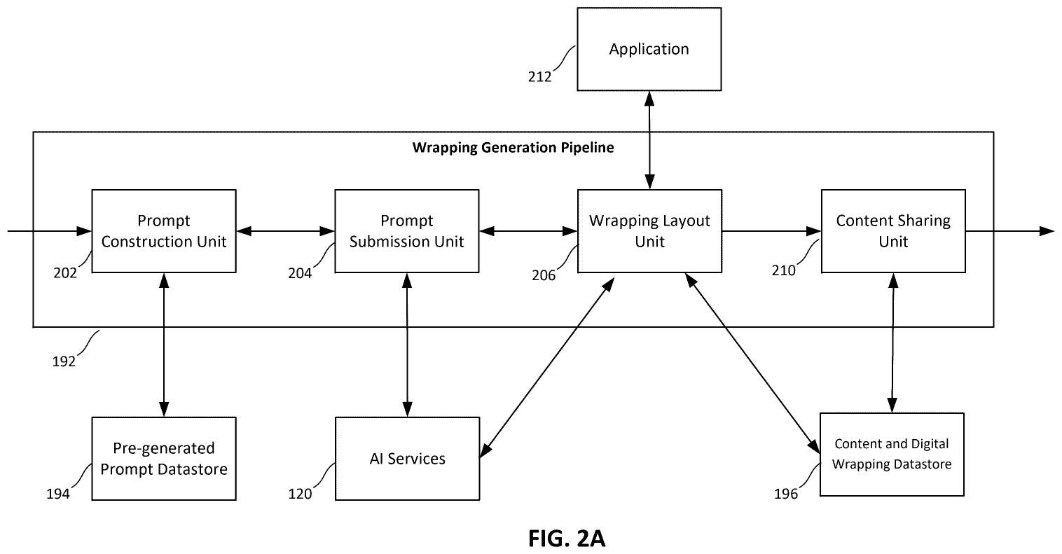

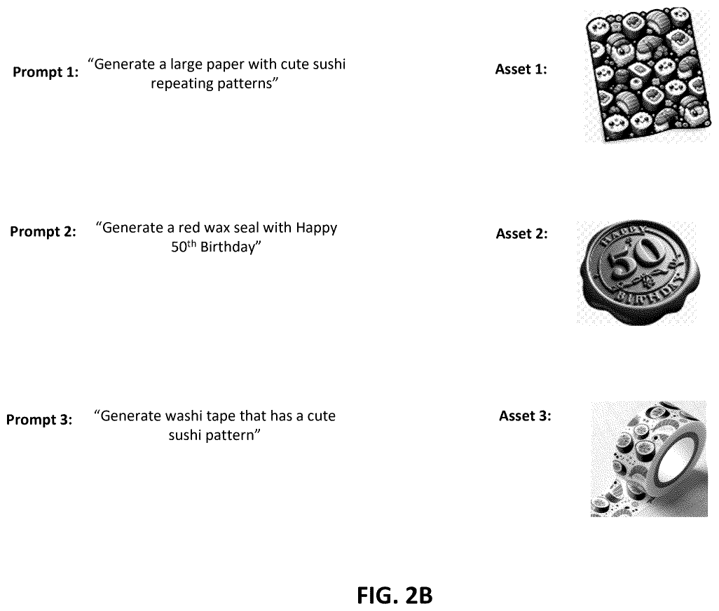

The wrapping generation pipeline 192 is a pipeline architecture that generates digital wrapping and/or accessories for a digital wrapping based on natural language prompts input by a user of an application implemented by the web application 190 and/or the native application 114. The input may also include content to be presented with the digital wrapper, such as an image, video, or other content item that has been generated with the assistance of the AI services 120. The wrapping generation pipeline 192 generates the digital wrapping and/or accessories and stores these items in the content and digital wrapping datastore 196 with the content item to be shared with other users. The content and digital wrapping datastore 196 can also store information indicating which users the content item and associated digital wrapping and/or accessories has been shared with. The user information may include an email address or other identifier of the users with whom the content item has been shared. Additional details of the wrapping generation pipeline 192 are shown in FIG. 2A.

The pre-generated prompt datastore 194 is a persistent datastore in a memory of the application services platform 110. The pre-generated prompt datastore 194 includes a set of natural language prompt templates that have been constructed to cause the text-to-image generative language model 124 to generate the digital wrapping. The pre-generated prompt datastore 194 can include prompt templates that include instructions to the text-to-image generative language model 124 for generating envelopes or gift boxes. The pre-generated prompt datastore 194 can also include prompt templates that include instructions for causing the text-to-image generative language model 124 to generate digital accessories, such as but not limited to digital stickers, wax seals, ribbons, name tags, and/or other decorative items that can further enhance the digital wrapping. The specific prompt templates included in the pre-generated prompt datastore 194 may vary in different implementations. Furthermore, an administrator or other authorized user may construct new prompt templates to add to the pre-generated prompt datastore 194, and/or remove or modify existing prompt templates. The wrapping generation pipeline 192 selects templates from the pre-generated prompt datastore 194 and customizes these templates based on the natural language utterances received from the native application 114 and/or web application 190.

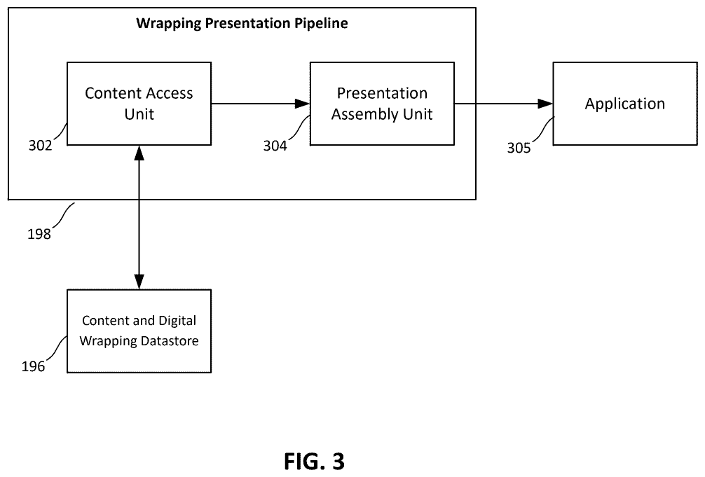

The wrapping presentation pipeline 198 facilitates the presentation of shared content and the digital wrapping on a user interface of the client device 105 of the recipient. The wrapping presentation pipeline 198 receives a request to access the content item and associated digital wrapping and/or accessories from the content and digital wrapping datastore 196. In some implementations, the recipient is provided a Uniform Resource Locator (URL) that is associated with the content item to be shared and any digital wrapping and/or accessories that have been generated for the content item. The digital wrapping may also be presented with an animation of the digital wrapping being opened to present the digital content. The wrapping presentation pipeline 198 facilitates the presentation of this animation on the client device 105 of the recipient. Additional details of the wrapping presentation pipeline 198 are shown in FIG. 3.

The AI services 120 provide various machine learning models that analyze and/or generate content for the labeled frame images datastore 196 and/or other components of the application services platform 110. The AI services 120 include a language model 122, a text-to-image generative language model 124, an image harmonization model 126, and an animation model 128 in the example implementation shown in FIG. 1. Other implementations may include additional models and/or a different combination of models to provide services to the various components of the application services platform 110.

The language model 122 is a machine learning model trained to generate textual content in response to natural language prompts input by a user via the native application 114 or via the browser application 112. The language model 122 is implemented using a large language model (LLM) in some implementations. Examples of such models include but are not limited to a Generative Pre-trained Transformer 3 (GPT-3), or GPT-4 model. The language model 122 is implemented using GPT-4 with Vision (GPT-4V). GPT-4V can receive images as an input and answer questions about those images. Other implementations may utilize other models or other generative models to generate textual content in response to user prompts. The language model 122 is used by the web application 190 and/or the native application 114 to generate textual content for cards, invitations, and/or other types of content that includes a textual element. The textual output from the language model 122 can be combined with images, video content, and/or other types of content generated using the various generative models provided by the AI services 120. The language model 122 can also be used by the wrapping generation pipeline 192 to generate textual content to be included in the digital wrapping and/or the accessories. The language model 122 can also be used to generate prompts to the other generative models of the AI services 120 based on natural language utterances received as an input from a user of the native application 114 and/or the web application 190.

The text-to-image generative language model 124 is a generative model that generates images based on textual natural language prompts describing the imagery to be generated. In some implementations, the text-to-image generative language model 124 is a multimodal model that can also receive a sample image or other content item as an input and customize the image that is output based on both the natural language prompt and the sample image. The text-to-image generative language model 124 is implemented using a GPT-4V model in some implementation. Other implementations utilize a different multimodal model instead of or in addition to GPT-4V and/or DALL-E. The wrapping generation pipeline 192 uses the text-to-image generative language model 124 to generate images that can be used as wrapping paper on a digital gift box or as an envelope used for sharing a digital content item with another user or users.

The image harmonization model 126 is a model that is configured to receive the digital wrapping and accessories and to harmonize the lighting, colors, and/or other attributes of the digital wrapping and the accessories to provide a well-integrated presentation of the digital wrapping and accessories. The image harmonization model 126 helps to remove any potentially jarring discontinuities in the appearances of the digital wrapping and the accessories. The image harmonization model 126 is implemented with a Parametric Image Harmonization (PIH) which harmonizes the attributes of composite images. Other types of harmonization models can also be used.

The animation model 128 receives the digital wrapping and any accessories and generates animation information that indicates how the digital wrapping and accessories are to be rendered on the client device 105 of the recipient. In some implementations, the animation model 128 generates information indicating how the digital wrapping and any accessories should appear and how these components should be animated. In a non-limiting example where the digital wrapping is an envelope, the animation model 128 generates animation information for applying images generated by the wrapping generation pipeline 192 to a two-dimensional (2D) or three-dimensional (3D) representation of the envelope and information indicating how the envelope should animated to open. In another non-limiting example where the digital wrapping is a gift box, the animation model 128 generates animation information for applying images generated by the wrapping generation pipeline 192 to a 2D or 3D representation of the gift box and information indicating how the gift box should be animated to open. The animation information also includes information indication how the accessories should be animated, such but not limited to how a ribbon should be untied, or a wax seal or sticker should be broken or torn to open the digital wrapping.

The services layer 140 receives natural language prompts from the native application 114, the web application 190, and/or the wrapping generation pipeline 192. The application 114 and/or the web application 190 provides natural language prompts input by a user in some instances, and the services layer 140 is configured to construct a prompt in a format recognized by each of the models. The services layer 140 can also submit pre-generated prompts from the pre-generated prompt datastore 194 to the text-to-image generative language model 124 and/or other models implemented by the AI services 120. In some implementations, the services layer 140 accesses a model-specific prompt template for each of the models of the AI services 120 from the pre-generated prompt datastore and uses the template to generate a model-specific prompt for each model. The wrapping generation pipeline 192 and/or other components of the application services platform 110 can also construct prompts to be submitted to one or more of the models implemented by the AI services 120. In such implementations, the services layer 140 receives the prompt as an input and submits the prompt to the respective model or models for processing.

The client device 105 is a computing device that may be implemented as a portable electronic device, such as a mobile phone, a tablet computer, a laptop computer, a portable digital assistant device, a portable game console, and/or other such devices in some implementations. The client device 105 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 1 includes a single client device 105, other implementations may include a different number of client devices that utilize services provided by the application services platform 110.

The client device 105 includes a native application 114 and a browser application 112. The native application 114 is a web-enabled native application, in some implementations, implements a design application as discussed above. The browser application 112 can be used for accessing and viewing web-based content provided by the application services platform 110. In such implementations, the application services platform 110 implements one or more web applications, such as the web application 190, that enables users to create content, including creating image frames for user-specified images. The application services platform 110 supports both the native application 114 and a web application 190 in some implementations, and the users may choose which approach best suits their needs.

FIG. 2A is a diagram showing an example implementation of the wrapping generation pipeline 192 shown in FIG. 1. The wrapping generation pipeline 192 incudes a prompt construction unit 202, a prompt submission unit 204, a wrapping layout unit 206, and content sharing unit 210. Other implementations of the wrapping generation pipeline 192 may include additional and/or other components in addition to those described herein.

The prompt construction unit 202 is configured to receive requests from the native application 114 and/or the web application 190 that include natural language utterances to generate digital wrapping and/or accessories for a content item that has been generated using one or more of the generative models of the AI services 120, and/or for a content item that has been otherwise obtained or generated. The prompt construction unit 202 receives the content item in addition to the natural language utterance in some implementations. The prompt construction unit 202 may alternatively receive a URL or other reference to the content and digital wrapping datastore 196 where the content item has been stored after being generated. The prompt construction unit 202 can access the pre-generated prompt datastore 194 to obtain one or more prompt templates. The prompt templates can include a prompt template for generating the digital wrapping, such as an envelope or gift box. The prompt templates may also optionally include one or more prompt templates for generating accessories, such as but not limited digital stickers, wax seals, ribbons, name tags, and/or other decorative items that can further enhance the digital wrapping. The prompt construction unit 202 may analyze the natural language utterance received as an input to identify keywords that indicate the type of digital wrapping to be generated and any optional accessories to also be generated. Each prompt template includes instructions to the text-to-image generative language model 124 to generate the digital wrapping and/or one or more accessories. The prompt construction unit 202 customizes the selected prompt or prompts with information extracted from the natural language utterance received as an input to the wrapping generation pipeline 192. The customized prompt templates are then provided to the prompt submission unit 204.

The prompt construction unit 202 can access user history and/or preferences information associated with the user submitting the request to generate the digital wrapping. The user history and/or preferences can identify design attributes that are preferred by the user and/or have typically been utilized by the user in past. These design attributes can include but are not limited to preferred patterns, color palettes, digital accessories, and/or other attributes of the digital wrapping to be generated. The prompt construction unit 202 can include these the user design preferences and/or user history in the prompts constructed by the prompt construction unit 202. These features can be used to customize the digital wrapping and/or digital accessors for the user.

The prompt submission unit 204 submits the customized prompt templates to the text-to-image generative language model 124 to generate the requested content. Some prompts may depend upon the output of a previous prompt, and the prompt submission unit 204 ensures that these prompts are submitted in the proper order. The prompt submission unit receives the output or outputs of the generative model or models and provides these outputs to the wrapping layout unit 206.

The wrapping layout unit 206 determines a layout of the digital wrapping and any accessories generated by the generative models of the AI services 120 in response to the prompts submitted by the prompt submission unit 204. The wrapping layout unit 206 can also harmonize the design of the digital wrapping and the accessories by submitting images comprising the digital wrapping and/or accessories to the image harmonization model 126. The wrapping layout unit 206 stores the layout information and harmonized images in the content and digital wrapping datastore 196. The wrapping layout unit 206 also presents digital wrapping and/or accessories, the layout of this content, and the animation generated in response to the prompts submitted by the prompt submission unit 204 on the user interface of the application 212 of a client device 105 of the user creating the content item. The application 212 can be implemented by the native application 114 and/or the web application 190. This approach enables the user to preview the digital wrapping, accessories, and/or animation thereof before the user sends the content item and digital wrapping to the recipient or recipients. The user interface enables the user to provide feedback on the digital wrapping and/or accessories via further natural language utterances. The wrapping layout unit 206 provides this feedback to the prompt submission unit 204, which can obtain a prompt template from the prompt construction unit 202 that provides instructions to the generative model or models to modify the digital wrapping and/or accessories based on the natural language utterance feedback provided by the user. The wrapping generation pipeline 192 can go through multiple iterations of generating content and modifying this content based on the user feedback until the user is satisfied with the digital wrapping and/or accessories.

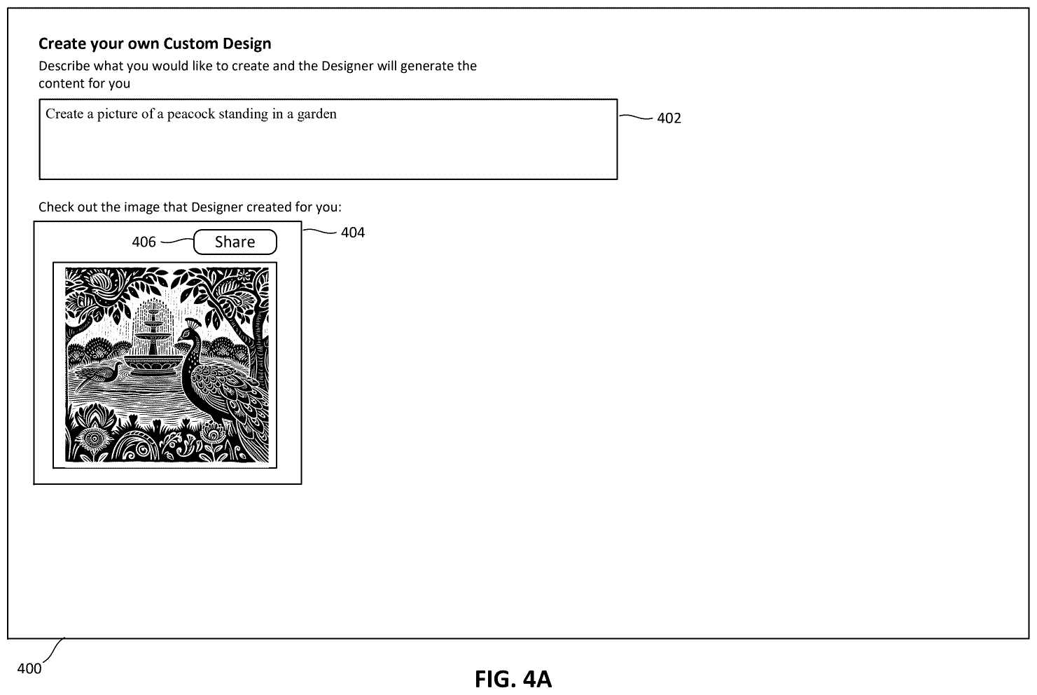

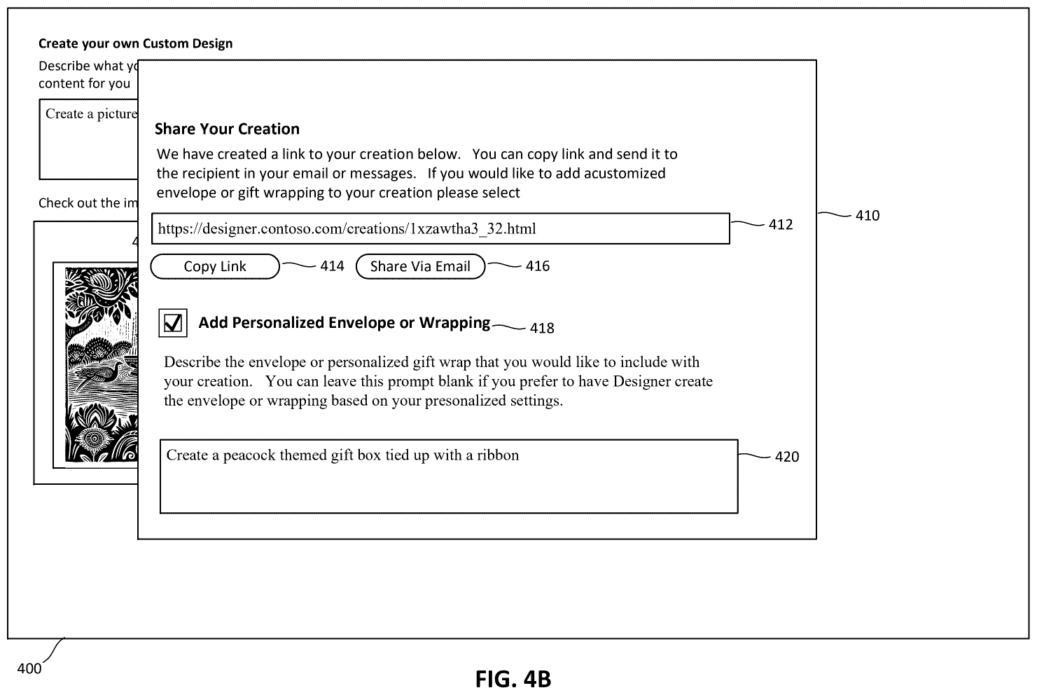

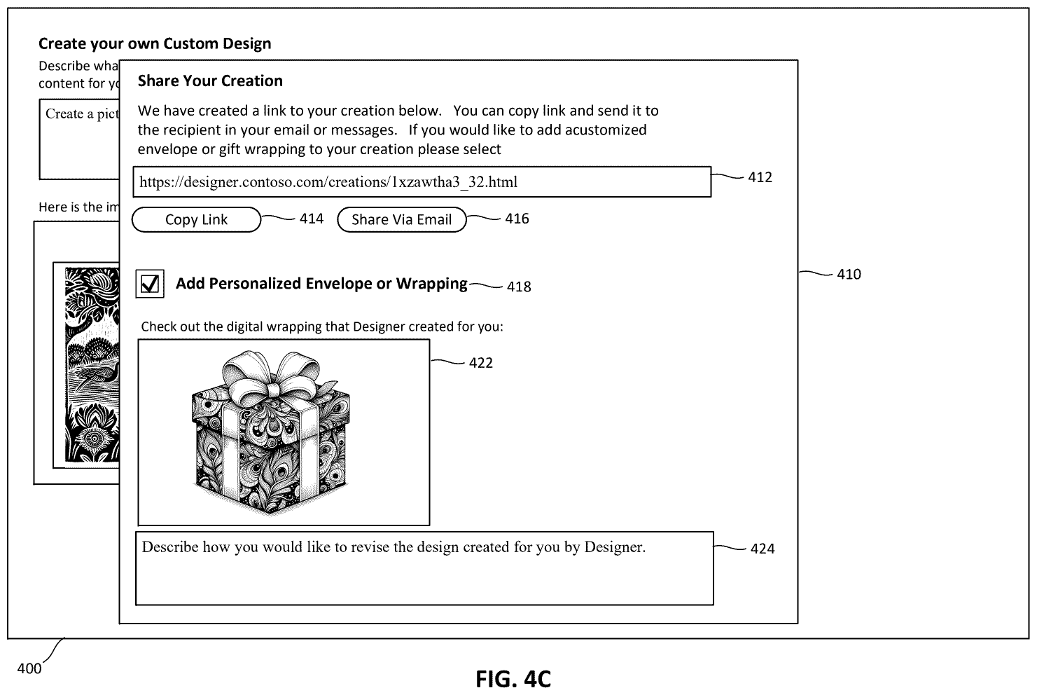

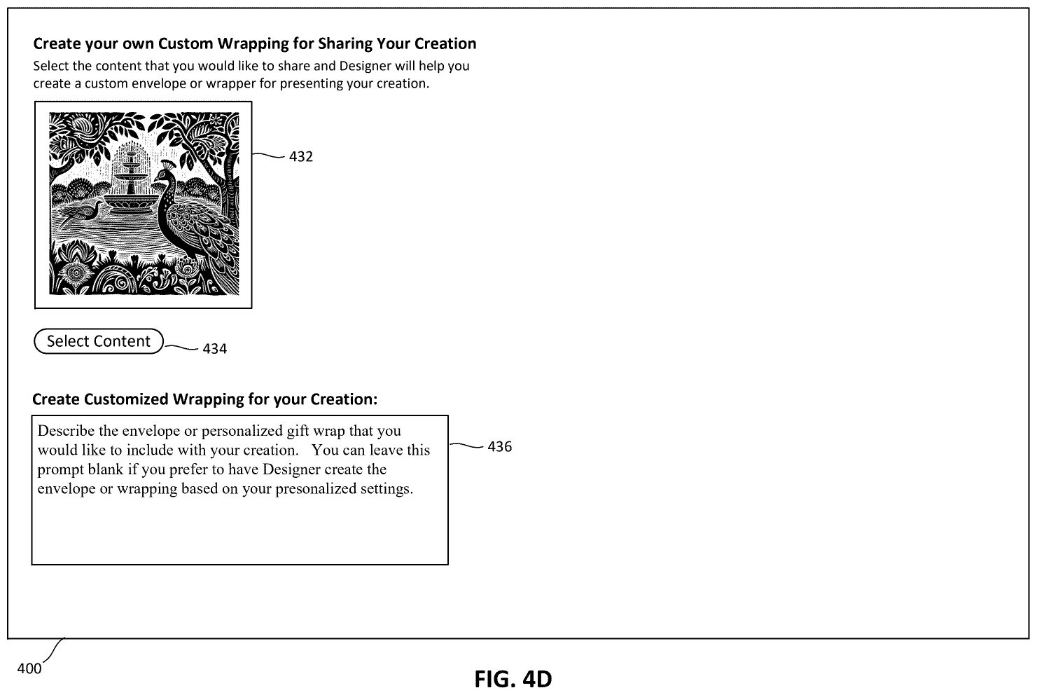

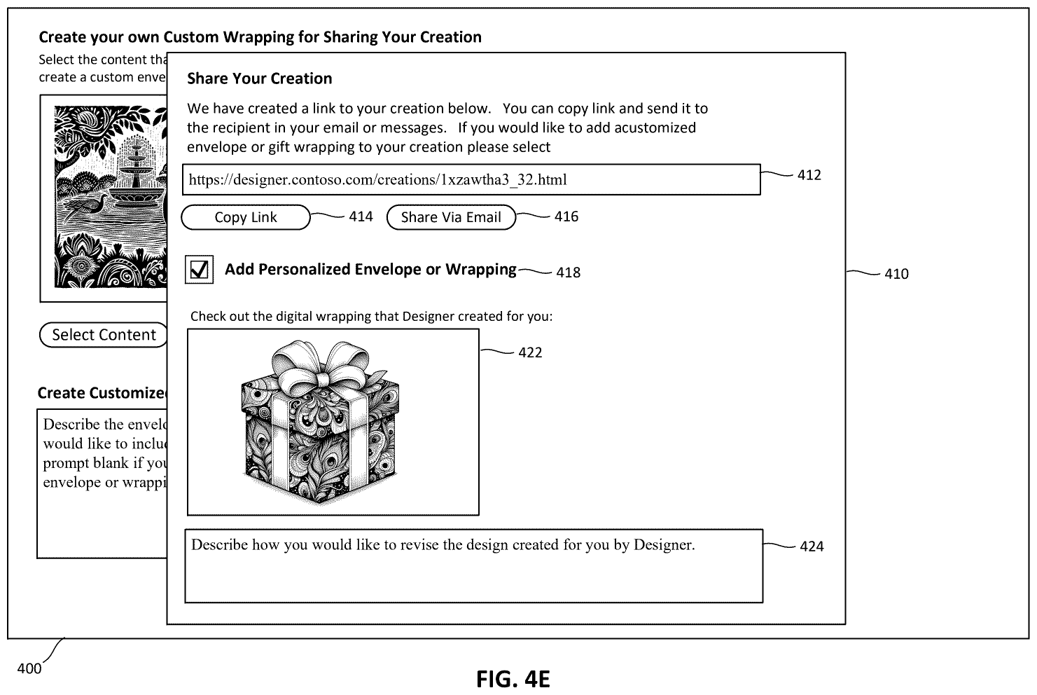

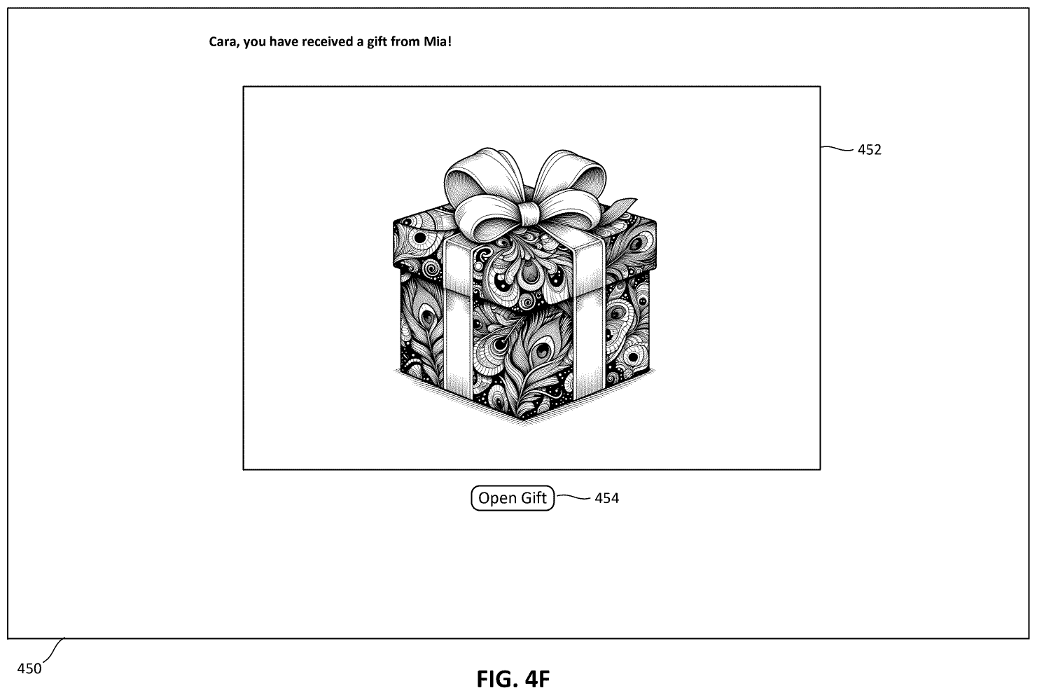

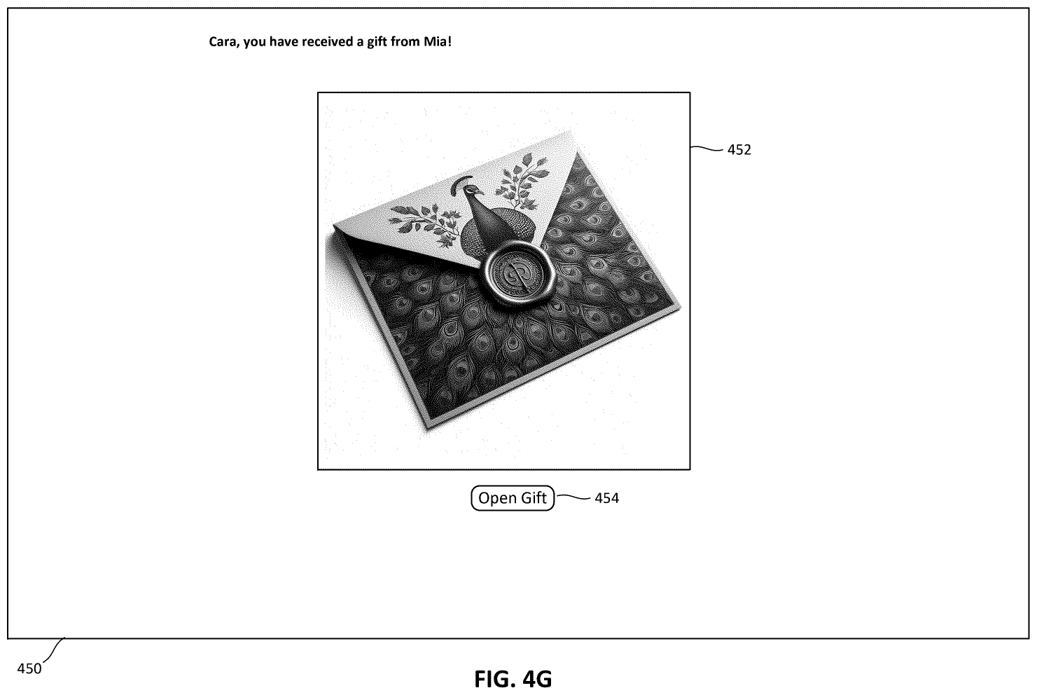

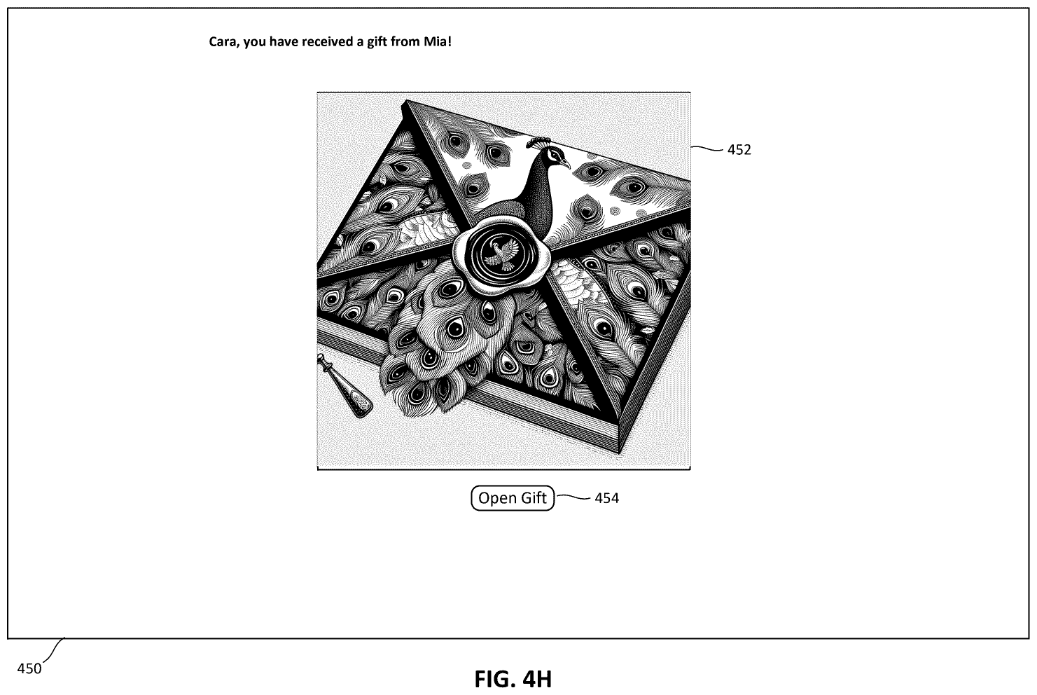

The content sharing unit 210 generates a URL that points to the location of the content item, digital wrapping, accessories, animation information, and/or other information associated with the content item in the content and digital wrapping datastore. The URL is sent to an intended recipient of the content item and the digital wrapping via email or another messaging service. The user can click on or otherwise activate this link to cause their client device 105 to present the content item and the digital wrapping on a user interface of an application on their client device 105. Additional details of the how the content items are presented on the client device of the recipient are shown in FIG. 3 and in FIGS. 4F-4H.

FIG. 2B is a diagram showing an example of a series of prompts constructed by the wrapping generation pipeline 192 used to generate digital wrapping and associated digital accessories. As discussed with respect to FIG. 2A, the wrapping generation pipeline 192 can construct multiple prompts to cause the text-to-image generative language model 124 to generate the digital wrapping, the digital accessories, and/or other image assets. The wrapping generation pipeline 192 uses the wrapping layout unit 206 to generate a layout for the presentation of the content item, digital wrapping, and accessories. FIG. 2B shows non-limiting examples of just a few of the items that may be generated by the wrapping generation pipeline 192. The wrapping generation pipeline 192 can generate a different set of digital wrapping and/or digital accessories based on the requests received from the user.

FIG. 3 is a diagram showing another example implementation of the wrapping presentation pipeline 198 shown in FIG. 1. The wrapping presentation pipeline 198 responds to requests from a client device 105 of a recipient to access content and digital wrapping that have been shared with the recipient. As discussed above, the wrapping generation pipeline 192 generates a URL that is provided to the recipient in an email message or other type of message. The recipient clicks on or otherwise activates the URL on the client device 105. The messaging application or email application may be a web-enabled application, or the device may open an application 305, such as the browser application 112 and/or the native application 114. The client device 105 sends an HTTP request to the application services platform 110 and the application services platform 110 parses the URL to extract a unique identifier that indicates which content and associated digital wrapping and/or accessories to present to the recipient. The content access unit 302 receives the unique identifier and obtains the content item, the digital wrapping and/or accessories, the animation information from the content and digital wrapping datastore 196.

The presentation assembly unit 304 prepares an HTTP response to the HTTP request that includes the content item, the digital wrapping and/or accessories, the animation information from the content and digital wrapping datastore 196. In some implementations, the animation information is JavaScript that implements the animation of the digital wrapping and/or the accessories in the application 305. Additional details of the presentation of the content item and the digital wrapping is provided in the examples which follow.

FIGS. 4A-4E are diagrams showing example user interfaces of an application which implements the techniques for generating digital wrapping according to the techniques disclosed herein. FIG. 4A shows an example of the user interface 400 of a design application that may be implemented by the native application 114 on the client device 105 or by the web application 190. The design application enables the user to input natural language utterances requesting that the application generate content items and share the content items. The design application also enables the user to input natural language utterances requesting that the design application generate digital wrapping and/or accessories for presenting the content item to a recipient or recipients.

The user interface 400 includes an input field 402 in which the user can input a natural language utterance describing a content item to be generated using the generative models of the AI services 120. The user interface 400 includes a results pane 404 that presents the content item generated in response to the natural language utterance input by the user in the input field 402. The results pane 404 includes a share control 406, which when activated, enables the user to share the content item with one or more recipients. The user may also optionally request that the application generate digital wrapping and/or accessories using the techniques discussed in the preceding examples.

FIG. 4B shows a content sharing pane 410 that is presented in response to the user clicking on or otherwise activating the share control 406. The content sharing pane 410 includes a link field 412 that includes a URL of the content item that can be provided to the recipient or recipients to enable the recipient to access the content item. The content sharing pane 410 includes a copy link control 414 and a share via email control 416. The copy link control 414, when clicked on or otherwise activated, causes the link to be copied to a clipboard of the client device 105 of the user and the user may then paste the link to an email or other message. The share via email control 416, when clicked or otherwise activated, causes the application to launch an email application on the client device 105 and to paste the link into a draft email. In some implementations, clicking on or otherwise activating the email control 416 instead causes the design application to present an email pane (not shown) in which the link is added to a body of the message and the user can enter the email address of one or more recipients with whom the content item should be shared.

The wrapping checkbox 418, when selected or otherwise activated, indicates that the user would like to add a personalized digital wrapping to the content item. As discussed in the preceding examples, the digital wrapping may be an envelope or gift box. The user may specify one or more accessories to add to the digital wrapping, such as but not limited to digital stickers, wax seals, ribbons, name tags, and/or other decorative items that can further enhance the digital wrapping. The user can enter a natural language utterance describing the digital wrapping and/or accessories in the input field 420. The wrapping generation pipeline 192 discussed in the preceding examples uses this natural language utterance and the content item to generate the digital wrapping and/or accessories as discussed in the preceding examples. FIG. 4C shows an example of the content sharing pane 410 in which a preview of the digital wrapping and/or accessories are presented in the preview pane 422. The user may also provide feedback in the form of additional natural language utterances in the input field 424, and the wrapping generation pipeline 192 revises the digital wrapping and/or accessories in response to the feedback as discussed in the preceding examples.

FIG. 4D shows another implementation of the user interface 400 in which the user can select a content item that has been previously created by clicking on or otherwise activating the select content button 434. The user may select an image, cards, announcements, invitations, drawings, graphics, posters, videos and/or other types of content. A preview of the selected content item is shown in the content pane 432. The user interface 400 also includes an input field 436 in which the user can input a natural language utterance that describes the digital wrapping that the user would like to have generated for sharing the content item with one or more recipients. The application provides the natural language prompt and the selected content item to the wrapping generation pipeline 192 to generate the digital wrapping as discussed in the preceding examples. FIG. 4E shows the content sharing pane 410 being displayed with the digital wrapping and/or accessories presented in the preview pane 422.

FIGS. 4F-4H show examples of a user interface 450 in which a recipient can view the content item and the digital wrapping shared with them in the preceding examples. The content pane 452 initially shows the wrapped content item. The user interface 450 is presented on the client device 105 of the recipient in response to the recipient clicking on or otherwise activating a link sent by the user sharing the content. As discussed in the preceding examples, the content presented in the user interface is sent to the client device 105 of the recipient by the wrapping presentation pipeline 198. In some implementations, the user interface 450 includes an open gift control 454 that the recipient can click on or otherwise activate to trigger the animation of the digital wrapping being opened and the content item being presented to the recipient. FIG. 4H includes an example in which a digital accessory, the peacock feather, protrudes from the seal. In such implementations, the feature is implemented using a mesh that is rigged and animated, such that the feather is animated as part of the unwrapping animation when the digital wrapping is opened. The wrapping generation pipeline 192 can analyze the image content generated by the text-to-image generative language model 124 to determine whether any such meshes will be required and generate the required meshes. The wrapping generation pipeline 192 analyzes the image content determine not only the meshes required but also how to reenforce these meshes so that the meshes deform property for the animation of the digital wrapping being opened.

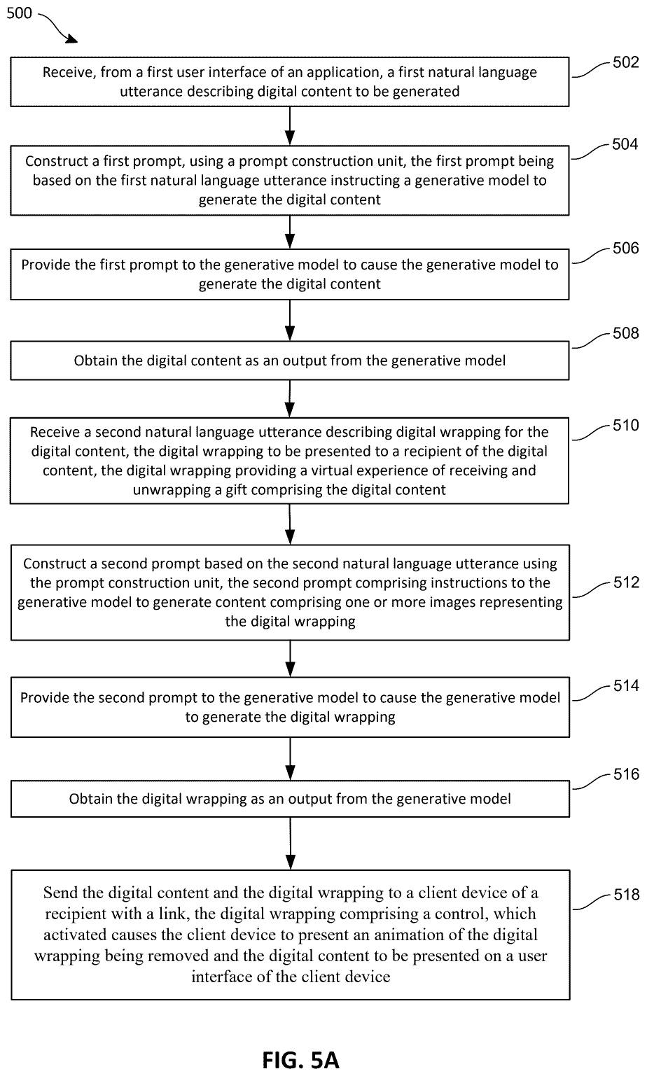

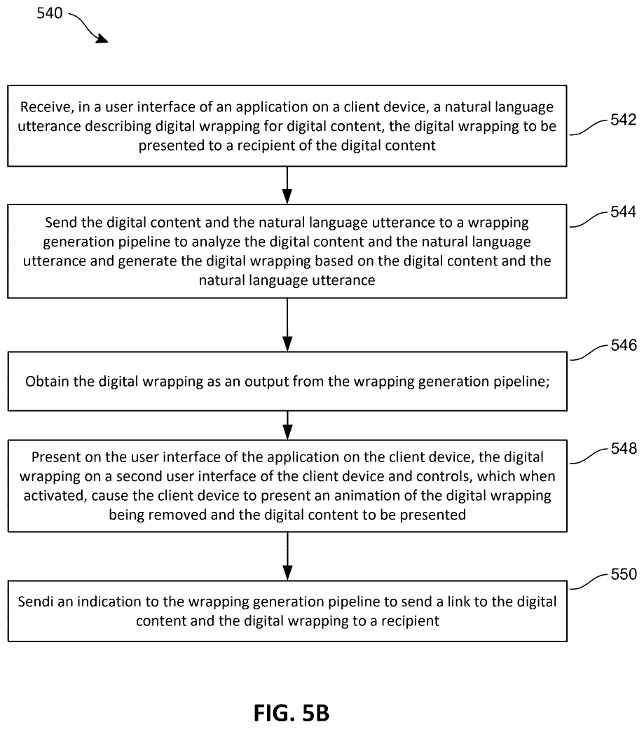

FIG. 5A is a flow chart of another example process 500 for automatically generating digital wrapping for a content item according to the techniques disclosed herein. The process 500 can be implemented by the application services platform 110 as discussed in the preceding examples.

The process 500 includes an operation 502 of receiving, from a first user interface of an application, a first natural language utterance describing digital content to be generated. As discussed in the preceding examples, a user can input a natural language utterance in a design application or application that enables the user to create content using generative AI. Examples of such a user interface are shown in FIGS. 4A-4E.

The process 500 includes an operation 504 of constructing a first prompt, using a prompt construction unit, an operation 506 of providing the first prompt to the generative model to cause the generative model to generate the digital content, and an operation 508 of obtaining the digital content as an output from the generative model. The first prompt is based on the first natural language utterance instructing a generative model to generate the digital content. The prompt construction unit 202 of the wrapping generation pipeline 192 constructs a prompt based on the natural language utterance in some implementations. In other implementations, the application may rely on the services layer 140 to construct the prompt to generate the content item. The digital content may be created using one or more generative models of the AI services 120.

The process 500 includes an operation 510 of receiving a second natural language utterance describing digital wrapping for the digital content, the digital wrapping to be presented to a recipient of the digital content, the digital wrapping providing a virtual experience of receiving and unwrapping a gift comprising the digital content an operation 512 of constructing a second prompt based on the second natural language utterance using the prompt construction unit, the second prompt comprising instructions to the generative model to generate content comprising one or more images representing the digital wrapping, an operation 514 of providing the second prompt to the generative model to cause the generative model to generate the digital wrapping, and an operation 516 of obtaining the digital wrapping as an output from the generative model. The digital wrapping is to be presented to a recipient of the digital content. As discussed in the preceding examples, the user may input a natural language prompt requesting that digital wrapping and/or accessories be created for sharing the content with a recipient or recipients. The wrapping generation pipeline 192 constructs a prompt or prompts based on the second natural language utterance to cause the generative models of the AI services 120 to generate the digital wrapping.

The process 500 includes an operation 518 of Send the digital content and the digital wrapping to a client device of a recipient with a link, the digital wrapping comprising a control, which activated causes the client device to present an animation of the digital wrapping being removed and the digital content to be presented on a user interface of the client device. As discussed in the preceding examples, the wrapping generation pipeline 192 can generate a URL that enables a recipient to view the digital content item and the digital wrapping on their client device 105. An example of such a user interface is shown in FIGS. 4F and 4G.

FIG. 5B is a flow chart of another example process 540 for automatically presenting digital wrapping for a content item according to the techniques disclosed herein. The process 540 can be implemented by the client device 105 as discussed in the preceding examples.

The process 540 includes an operation 542 of receiving, in a user interface of an application on a client device, a natural language utterance describing digital wrapping for digital content, the digital wrapping to be presented to a recipient of the digital content. As discussed in the preceding examples, the user can enter a natural language utterance, such as the user interface 400 shown in FIGS. 4A-4E.

The process 540 includes an operation 544 of sending the digital content and the natural language utterance to a wrapping generation pipeline to analyze the digital content and the natural language utterance and generate the digital wrapping based on the digital content and the natural language utterance. The application, which may be implemented by the native application 114 and/or the web application 190, provides natural language utterance and the content item to the wrapping generation pipeline 192 for processing.

The process 540 includes an operation 546 of obtaining the digital wrapping as an output from the wrapping generation pipeline 192. The digital wrapping pipeline 192 outputs the digital wrapping and/or any digital accessories requested in the natural language prompt.

The process 540 includes an operation 548 of presenting, on the user interface of the application on the client device, the digital wrapping on a second user interface of the client device and controls, which when activated, cause the client device to present an animation of the digital wrapping being removed and the digital content to be presented. As discussed in the preceding examples, the user interface 400 provides the user with a preview of the digital wrapping that the user can accept and send to one or more recipients or request that modifications be made in one or more follow up natural language utterances.

The process 540 includes an operation 550 of sending an indication to the wrapping generation pipeline to send a link to the digital content and the digital wrapping to a recipient. The user can share a link to the digital content and the digital wrapping with one or more recipients.

The detailed examples of systems, devices, and techniques described in connection with FIGS. 1-5B are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-5B are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

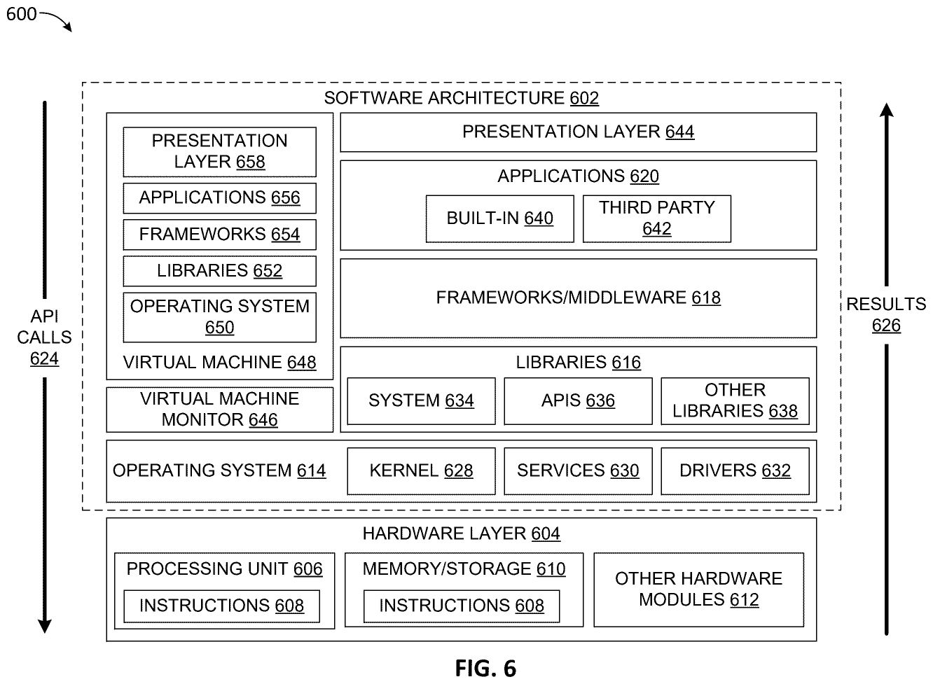

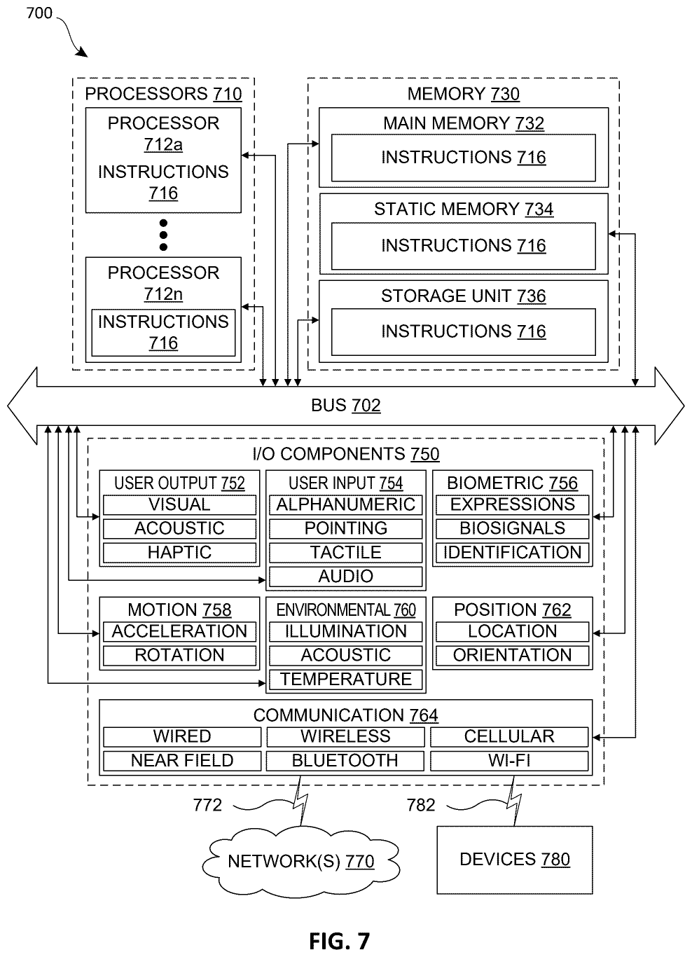

FIG. 6 is a block diagram 600 illustrating an example software architecture 602, various portions of which may be used in conjunction with various hardware architectures herein described, which may implement any of the above-described features. FIG. 6 is a non-limiting example of a software architecture, and it will be appreciated that many other architectures may be implemented to facilitate the functionality described herein. The software architecture 602 may execute on hardware such as a machine 700 of FIG. 7 that includes, among other things, processors 710, memory/storage, and input/output (I/O) components 750. A representative hardware layer 604 is illustrated and can represent, for example, the machine 700 of FIG. 7. The representative hardware layer 604 includes a processing unit 606 and associated executable instructions 608. The executable instructions 608 represent executable instructions of the software architecture 602, including implementation of the methods, modules and so forth described herein. The hardware layer 604 also includes a memory/storage 610, which also includes the executable instructions 608 and accompanying data. The hardware layer 604 may also include other hardware modules 612. Instructions 608 held by processing unit 606 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks/middleware 618, applications 620, and a presentation layer 644. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks/middleware 618 provide a higher-level common infrastructure that may be used by the applications 620 and/or other software modules. For example, the frameworks/middleware 618 may provide various graphic user interface (GUI) functions, high-level resource management, or high-level location services. The frameworks/middleware 618 may provide a broad spectrum of other APIs for applications 620 and/or other software modules.

The applications 620 include built-in applications 640 and/or third-party applications 642. Examples of built-in applications 640 may include, but are not limited to, a contacts application, a browser application, a location application, a media application, a messaging application, and/or a game application. Third-party applications 642 may include any applications developed by an entity other than the vendor of the particular platform. The applications 620 may use functions available via OS 614, libraries 616, frameworks/middleware 618, and presentation layer 644 to create user interfaces to interact with users.

Some software architectures use virtual machines, as illustrated by a virtual machine 648. The virtual machine 648 provides an execution environment where applications/modules can execute as if they were executing on a hardware machine (such as the machine 700 of FIG. 7, for example). The virtual machine 648 may be hosted by a host OS (for example, OS 614) or hypervisor, and may have a virtual machine monitor 646 which manages operation of the virtual machine 648 and interoperation with the host operating system. A software architecture, which may be different from software architecture 602 outside of the virtual machine, executes within the virtual machine 648 such as an OS 650, libraries 652, frameworks 654, applications 656, and/or a presentation layer 658.

FIG. 7 is a block diagram illustrating components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement modules or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 716.

The machine 700 may include processors 710, memory/storage 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multicore processor including cores that may execute instructions contemporaneously. Although FIG. 7 shows multiple processors, the machine 700 may include a single processor with a single core, a single processor with multiple cores (for example, a multicore processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The particular examples of I/O components illustrated in FIG. 7 are in no way limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756, motion components 758, environmental components 760, and/or position components 762, among a wide array of other physical sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 758 may include, for example, acceleration sensors (for example, an accelerometer) and rotation sensors (for example, a gyroscope). The environmental components 760 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 762 may include, for example, location sensors (for example, a Global Position System (GPS) receiver), altitude sensors (for example, an air pressure sensor from which altitude may be derived), and/or orientation sensors (for example, magnetometers).

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 764 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 764, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory storing executable instructions that, when executed, cause the processor alone or in combination with other processors to perform operations of:
receiving, from a first user interface of an application, a first natural language utterance describing digital content to be generated;
constructing a first prompt, using a prompt construction unit, the first prompt being based on the first natural language utterance instructing a generative model to generate the digital content;
providing the first prompt to the generative model to cause the generative model to generate the digital content;
obtaining the digital content as an output from the generative model;
receiving a second natural language utterance describing digital wrapping for the digital content, the digital wrapping to be presented to a recipient of the digital content, the digital wrapping providing a virtual experience of receiving and unwrapping a gift comprising the digital content;
constructing a second prompt based on the second natural language utterance using the prompt construction unit, the second prompt comprising instructions to the generative model to generate content comprising one or more images representing the digital wrapping;
providing the second prompt to the generative model to cause the generative model to generate the digital wrapping;
obtaining the digital wrapping as an output from the generative model; and
sending the digital content and the digital wrapping to a client device of a recipient with a link, the digital wrapping comprising a control, which activated causes the client device to present an animation of the digital wrapping being removed and the digital content to be presented on a user interface of the client device.

2. The data processing system of claim 1, wherein constructing the second prompt further comprises:
accessing a first prompt template from a prompt datastore, the first prompt template comprising first instructions to generate the digital wrapping for the digital content based on the second natural language utterance; and
customizing the first prompt template based on the second natural language utterance.

3. The data processing system of claim 2, wherein the first instructions instruct the generative model to generate a digital wrapping paper for a virtual gift box.

4. The data processing system of claim 2, wherein the first instructions instruct the generative model to generate a virtual envelope.

5. The data processing system of claim 2, wherein the memory further includes instructions configured to cause the processor alone or in combination with other processors to perform operations of:
accessing a second prompt template from a prompt datastore, the second prompt template comprising first instructions to generate one or more digital accessories for the digital wrapping based on the second natural language utterance;
customizing the second prompt template based on the second natural language utterance to generate a third prompt; and
providing the third prompt to the generative model to cause the generative model to generate the one or more digital accessories.

6. The data processing system of claim 5, wherein the memory further includes instructions configured to cause the processor alone or in combination with other processors to perform operations of:
storing the one or more digital accessories in a content datastore; and
associating the one or more digital accessories with the digital content and the digital wrapping.

7. The data processing system of claim 5, wherein sending the digital content and the digital wrapping to the client device of the recipient further comprises sending the one or more digital accessories to the client device of the recipient.

8. The data processing system of claim 1, wherein sending the digital content and the digital wrapping to the client device of the recipient further comprises:
generating a link referencing a storage location of the digital content and the digital wrapping, the link when activated causes the client device to access the storage location of the digital content and the digital wrapping and obtain a copy of the digital content and the digital wrapping from the storage location; and
sending the link to the client device of the recipient.

9. The data processing system of claim 5, wherein the memory further includes instructions configured to cause the processor alone or in combination with other processors to perform operations of:
receiving a third natural language utterance via the first user interface of the application, the third natural language utterance providing feedback requesting that the generative model modify the digital wrapping;
constructing a third natural language prompt based on the third natural language prompt using the prompt construction unit; and
providing the third prompt and the digital wrapping to the generative model to cause the generative model to modify the digital wrapping.

10. The data processing system of claim 1, wherein the memory further includes instructions configured to cause the processor alone or in combination with other processors to perform operations of:
generating the animation using an animation model.

11. The data processing system of claim 10, wherein the generative model is a large language model (LLM).

12. The data processing system of claim 1, wherein constructing the second prompt further comprises constructing a plurality of second prompts based on the second natural language utterance, each prompt of the plurality of second prompts instructing the generative model to generate one or more images representing the digital wrapping or one or more digital accessories, and wherein providing the plurality of second prompts to the generative model to cause the generative model to generate the one or more images representing the digital wrapping and the one or more digital accessories.

13. A method implemented in a data processing system for generating virtual wrapping for digital content, the method comprising:
receiving, from a first user interface of an application, a first natural language utterance describing digital content to be generated;
constructing a first prompt, using a prompt construction unit, the first prompt being based on the first natural language utterance instructing a generative model to generate the digital content;
providing the first prompt to the generative model to cause the generative model to generate the digital content;
obtaining the digital content as an output from the generative model;
receiving a second natural language utterance describing digital wrapping for the digital content, the digital wrapping to be presented to a recipient of the digital content, the digital wrapping providing a virtual experience of receiving and unwrapping a gift comprising the digital content;
constructing a second prompt based on the second natural language utterance using the prompt construction unit, the second prompt comprising instructions to the generative model to generate content comprising one or more images representing the digital wrapping;
providing the second prompt to the generative model to cause the generative model to generate the digital wrapping;
obtaining the digital wrapping as an output from the generative model; and
sending the digital content and the digital wrapping to a client device of a recipient with a link, the digital wrapping comprising a control, which activated causes the client device to present an animation of the digital wrapping being removed and the digital content to be presented on a user interface of the client device.

14. The method of claim 13, wherein constructing the second prompt further comprises:
accessing a first prompt template from a prompt datastore, the first prompt template comprising first instructions to generate the digital wrapping for the digital content based on the second natural language utterance; and
customizing the first prompt template based on the second natural language utterance.

15. The method of claim 14, wherein the first instructions instruct the generative model to generate a digital wrapping paper for a virtual gift box.

16. The method of claim 14, wherein the first instructions instruct the generative model to generate a virtual envelope.

17. A data processing system comprising:
a processor; and
a memory storing executable instructions that, when executed, cause the processor alone or in combination with other processors to perform operations of:
receiving, in a user interface of an application on a client device, a natural language utterance describing digital wrapping for digital content, the digital wrapping to be presented to a recipient of the digital content;
sending the digital content and the natural language utterance to a wrapping generation pipeline to analyze the digital content and the natural language utterance and generate the digital wrapping based on the digital content and the natural language utterance;
obtaining the digital wrapping as an output from the wrapping generation pipeline;
presenting, on the user interface of the application on the client device, the digital wrapping on a second user interface of the client device and controls, which when activated, cause the client device to present an animation of the digital wrapping being removed and the digital content to be presented; and
sending an indication to the wrapping generation pipeline to send a link to the digital content and the digital wrapping to a recipient.

18. The data processing system of claim 17, wherein the natural language utterance includes instructions to generate one or more ne or more digital accessories to enhance the digital wrapping.

19. The data processing system of claim 18, wherein the natural language utterance further requests that the wrapping generation pipeline generate a digital wrapping paper for a virtual gift box.

20. The data processing system of claim 18, wherein the natural language utterance further requests that the wrapping generation pipeline generate a virtual envelope.
